(19) United States
(12) Patent Application Publication
(10) Pub. No.: US 2012/0140393 A1
(43) Pub. Date: Jun. 7, 2012

(54) PROTECTIVE CASE

(75) Inventors: Shun-Chien Lan, Taipei (TW); Guan-Hua Tzeng, Taipei (TW)

(73) Assignee: CHENG UEI PRECISION INDUSTRY CO., LTD., Taipei (TW)

(21) Appl. No.: 12/959,757

(22) Filed: Dec. 3, 2010

(51) Int. Cl. G06F 1/16

(52) U.S. Cl. 361/679.02

(57) ABSTRACT

A protective case for a tablet computer includes a main body for receiving the tablet computer therein and an inserting connector disposed in the main body. The main body has a receiving cavity for receiving a battery. The inserting connector is capable of electrically connecting the tablet computer with the battery when the tablet computer and the battery are received in the main body. Therefore, the tablet computer can be used in a longer continuous time by means of the battery providing electricity to the tablet computer.

### BACKGROUND OF THE INVENTION

1. Field of the Invention

The present invention relates to a protective case, and particularly to a protective case for a tablet computer.

2. The Related Art

In recent years, with the high-speed development of electronic technology, there are many different kinds of tablet computers having arisen in electronic market. Correspondingly, in order to avoid scraping the surfaces of the tablet computer, there are also different kinds of protective cases provided to customer. Meanwhile, the tablet computer is required to be miniaturized more and more. Correspondingly, a battery of the tablet computer becomes smaller which leads the volume of the battery become smaller than before, so the users can not use the tablet computer in long time.

However, the conventional protective case is only used to protect the tablet computer. Meanwhile, as the volume of the battery becomes smaller than before, how to provide electricity to the tablet computer continuously in a long time becomes urgent. If a protective case can hold a battery to provide electricity to the tablet computer, the problem that the users can not use the tablet computer in a long time will be resolved.

### SUMMARY OF THE INVENTION

Accordingly, an object of the present invention is to provide a protective case for a tablet computer. The protective case includes a main body for receiving the tablet computer therein. The main body has a receiving cavity for receiving a battery. An inserting connector disposed in the main body is capable of electrically connecting the tablet computer with the battery when the tablet computer and the battery are received in the main body.

As described above, the battery of the protective case can provide electricity to the tablet computer by means of the inserting connector electrically connecting with the battery and the tablet computer, therefore, the tablet computer can be used in a longer continuous time than the tablet computer shown in related art.

### BRIEF DESCRIPTION OF THE DRAWINGS

The present invention will be apparent to those skilled in the art by reading the following description thereof, with reference to the attached drawings, in which:

FIG. 1 is a perspective view of a protective case in accordance with the present invention;

FIG. 2 is a perspective view of the protective case of FIG. 1 with a protective cover of the protective case being opened; and

FIG. 3 is an exploded, perspective view of the protective case of FIG. 1 wherein a battery is taken apart from a receiving room of the protective case.

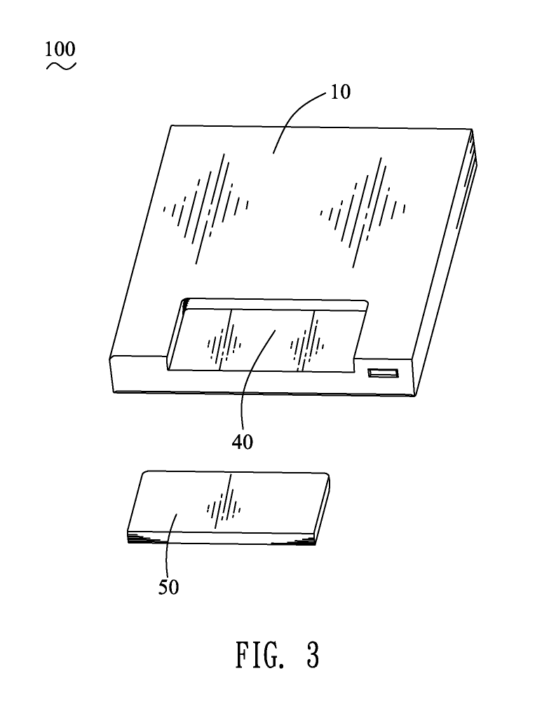

### DETAILED DESCRIPTION OF THE EMBODIMENT

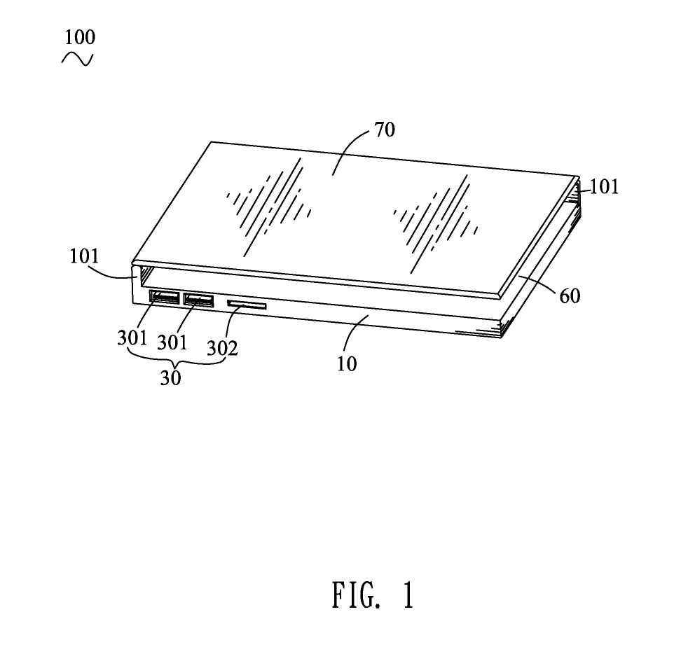

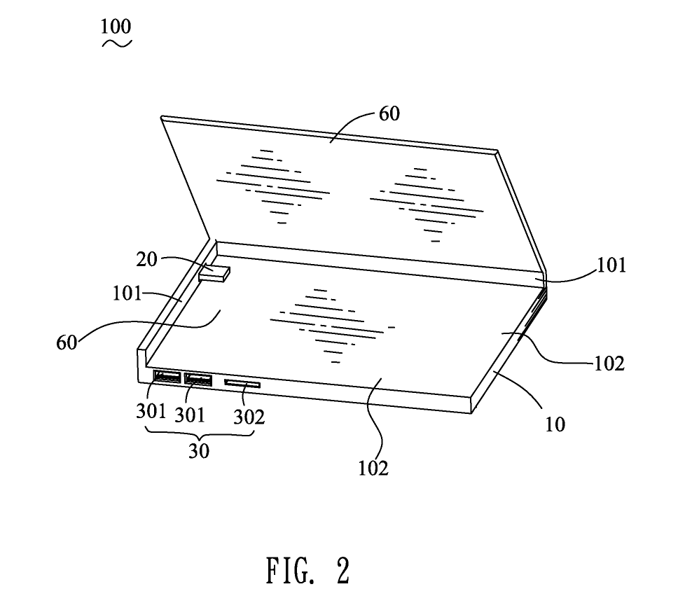

Referring to the drawings in greater detail, and first to FIGS. 1-2, the embodiment of the invention is embodied in a protective case 100. The protective case 100 is used to receive a tablet computer (not shown) therein and is capable of electrically connecting the tablet computer. The protective case 100 has a substantial rectangular main body 10 for receiving the tablet computer therein. The main body 10 has a receiving cavity 40 for receiving a battery 50. In this embodiment, the receiving cavity 40 is disposed at a bottom surface of the main body 10 and penetrates an end of the main body 10. An inserting connector 20 is disposed in the main body 10. The inserting connector 20 is capable of electrically connecting the tablet computer and the battery 50 when the tablet computer and the battery 50 are received in the main body 10. In this embodiment, the inserting connector 20 is a dock connector for being inserted into a dock interface (not shown) of the tablet computer. The dock connector is a connector used to attach a mobile electronic device simultaneously to multiple external resources. The dock connector can typically carry a variety of signals and power, through a single connector, to simplify the process of docking the mobile device. The receiving cavity 40 is defined at a same end of the main body 10 as the inserting connector 20 with respect to the main body 10 and back to the tablet computer when the tablet computer is received in the main body 10. The main body 10 has three external connectors 30 disposed therein for electrically connecting with an accessory (not shown) for the tablet computer. The inserting connector 20 and the external connectors 30 electrically connect with each other. The external connectors 30 include a card connector 302 for reading a card (not shown) and two USB connectors 301. The main body 10 has two side walls 101 extended from two adjacent side edges thereof. Two openings 102 are correspondingly formed at the other two adjacent side edges of the main body 10. The main body 10 and the two side walls 101 collectively define a receiving room 60 for receiving the tablet computer. The inserting connector 20 is disposed to one side wall 101 of the main body 10 and extends inward into the receiving room 60 for being inserted into a corresponding interface of the tablet computer. The protective case 100 further comprises a cover 70 movably covering the receiving room 60. When the installment of the tablet computer is finished and the tablet computer is unused, the cover 70 is capable of covering the receiving room 60 for protecting the tablet computer. In this case, the cover 70 pivotally connects to the other side wall 101 different from the side wall 101 where the inserting connector 20 is disposed.

When the tablet computer is received in the receiving room 60 of the protective case 100, the inserting connector 20 is capable of electrically connecting the tablet computer and the external connectors 30, therefore, the users can realize exchanges of datum between the tablet computer and outer electronic devices (not shown) by means of the external connectors 30 electrically connecting with the outer electronic devices. Furthermore, the battery 50 of the protective case 100 can provide electricity to the tablet computer by means of the inserting connector 20 electrically connecting with the battery 50 and the tablet computer.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A protective case for a tablet computer, comprising:
a main body for receiving the tablet computer therein, the main body having a receiving cavity for receiving a battery; and
an inserting connector disposed in the main body, the inserting connector capable of electrically connecting the tablet computer with the battery when the tablet computer and the battery are received in the main body.

2. The protective case claimed in claim 1, wherein the inserting connector is a dock connector for being inserted into a dock interface of the tablet computer.

3. The protective case claimed in claim 2, wherein the main body has at least one external connector disposed therein for electrically connecting with an accessory for the tablet computer, the inserting connector and the external connector electrically connecting with each other.

4. The protective case claimed in claim 3, wherein the at least one external connector includes a card connector for reading a card.

5. The protective case claimed in claim 3, wherein the at least one external connector further includes a USB connector.

6. The protective case claimed in claim 1, wherein the main body includes two side walls extended from two adjacent side edges thereof, two openings are correspondingly at the other two adjacent side edges of the main body.

7. The protective case claimed in claim 1, wherein the main body and the two side walls collectively define a receiving room for receiving the tablet computer therein.

8. The protective case claimed in claim 7, wherein the inserting connector is disposed to a side wall of the main body and extends inward into the receiving room for the tablet computer for being inserted into a corresponding interface of the tablet computer.

9. The protective case claimed in claim 8, wherein the protective case further comprises a cover movably covering the receiving room, when the installment of the tablet computer is finished and the tablet computer is unused, the cover capable of covering the receiving room for protecting the tablet computer.

10. The protective case claimed in claim 9, wherein the cover pivotally connects to one of the side walls.

11. The protective case claimed in claim 10, wherein the one side wall where the cover being connected is different from the other side wall where the inserting connector is disposed.

12. The protective case claimed in claim 1, wherein the receiving cavity is defined at a same end of the main body as the inserting connector with respect to the main body and back to the tablet computer when the tablet computer is received in the main body.
